(19) United States
(12) Patent Application Publication
(10) Pub. No.: US 2003/0199102 A1
(43) Pub. Date: Oct. 23, 2003

(54) Test tray, kit and methods for bodily fluid testing for newborn screening by tandem mass spectrometry

(75) Inventor: Jan Ostrup, Kaarina (FI)

Correspondence Address: STANDLEY & GILCREST LLP, 495 METRO PLACE SOUTH, SUITE 210, DUBLIN, OH, 43017, US

(73) Assignee: PerkinElmer Life Sciences, Inc.

(21) Appl. No.: 10/458,831

(22) Filed: Jun. 11, 2003

Related U.S. Application Data
(63) Continuation of application No. 09/474,604, filed on Dec. 29, 1999, now abandoned.

(51) Int. Cl. B01L 3/00

(52) U.S. Cl. 436/173; 422/102

(57) ABSTRACT

This invention relates to a test tray, kit and methods for use in the screening of newborns for metabolic disorders such as by tandem mass spectrometry. Individually stored dried standards are placed in a plurality of cells in a tray test.

This application is a continuation of U.S. Provisional Application No. 09/474,604, filed Dec. 29, 1999, which is hereby incorporated by reference in its entirety.

### TECHNICAL FIELD

The present invention is in the field of equipment, kits and methods for testing bodily fluids for newborn screening by tandem mass spectrometry kits.

### BACKGROUND

Newborn infants are screened for metabolic disorders in all developed countries of the world. In addition, newborn screening is beginning to be adopted by many developing countries around the world. Prior to the use of tandem mass spectrometry by some newborn screening programs, the number of inherited disorders screened has been limited in most programs. In the US, typically a program will screen for no more than six disorders.

To increase the number of disorders screened and to screen for fatty acid metabolism disorders, some programs have adopted tandem mass spectrometry for screening newborns. This allows screening for multiple disorders from a single blood spot punch. The tandem mass screening is typically carried out by extracting a sample of the child's blood from the punched blood spot with a solvent, such as methanol, which also contains isotopically labeled standards of known concentration. The amount of material measured in the blood spot extract by tandem mass spectrometry is inferred by observation of the ratio of instrument response of the known standard to the unknown substance undergoing analysis. Usually the internal standards are prepared as a solution and stored over a period of time, until the solution is consumed. Storage of these alcoholic solutions of internal standards can lead to problems in quantitation due to evaporation of the solvent. This evaporation can occur over periods of time even if precautions are taken to avoid it due to the repeated opening of the standard solution container for use. Any carelessness in use or storage of the standard solutions will exacerbate this problem. Evaporation of the solvent will lead to incorrect calculation of the amount of analyte because the concentration of the standards is no longer reliably known.

When the standards are stored as solids, those such as the acylcarnitines are subject to degradation through hydrolysis. This has limited the usefulness of dry standards, since they must be stored under inert gasses and at low temperatures. The solid standards were known to be stable at low temperatures when stored under nitrogen. These conditions do not allow for an efficient manufacture of individual samples of the standards, their economical shipment to customer sites, or the storage of the individual samples at the user site.

Accordingly, it is desirable to be able to produce test trays and test kits, and related methods, that provide for more accurate and reliable testing through use of more concentration stable internal standards.

Is also desirable to produce test trays and test kits that offer convenient storage, transport and use of internal standards attendant to testing such as newborn screening. Is also beneficial to be able to provide these advantages while maintaining the stability of these internal standards.

Although described against the backdrop of newborn screening techniques, other advantages of the present invention may become apparent to one of ordinary skill through use of the invention in this field or in other applications.

### SUMMARY OF THE INVENTION

Accordingly, the present invention includes test trays, a method of their manufacture, and kits and analytical methods using them.

The testing tray for conducting a plurality of tests on a biological fluid comprises: (a) a test tray comprising a plurality of cells; and (b) at least two of the cells containing a dried internal standard used in each respective ones of the plurality of tests.

The dried internal standard may include any appropriate internal standard for the desired test(s), preferably an isotope labeled standard selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof.

It is also preferred that the testing tray be provided with a cover piece, such as a polymeric, aseptic covering, and that it be packaged to prevent contamination and to facilitate storage and shipping.

The present invention also includes a method of conducting a plurality of tests to assay analytes in a bodily fluid sample fluid, the method comprising: (a) obtaining a sample of bodily fluid; (b) placing aliquots of the bodily fluid sample in a plurality of cells of a test tray, the test tray comprising: (i) a plurality of cells; and (ii) at least two of the cells containing a dried internal standard used in each of the tests; so as to produce a respective plurality of test/standard samples, followed by (c) performing an assay test on each of the respective plurality of test/standard samples.

The tests performed on each of the respective plurality of test/standard samples may include at least two tests adapted to assay different analytes from respective plurality of test/standard samples, or may include at least two tests adapted to assay the same analyte from respective test/standard samples (such as for repetitive testing), or a combination thereof.

Typically the plurality of tests will be conducted using tandem mass spectrometry.

The present invention also includes a kit including a test tray for conducting a plurality of tests to assay analytes in a bodily fluid, the kit comprising: (a) a testing tray comprising a plurality of cells; (b) at least two of the cells containing a dried internal standard; (c) a solvent for addition to the cells containing a dried internal standard (as described above); and (d) an optional solvent dispenser (such as a micropipette).

Also included in the present invention is a newborn blood screening test tray for conducting a plurality of tests on blood from a newborn human. The tray comprises: (a) a test tray comprising a plurality of cells; and (b) at least two of the cells containing a dried internal standard used in each respective ones of the plurality of tests (i.e., the same or different test performed on each test sample/standard in each cell after being provided with a solvent and blood sample). The dried internal standard may be any of those described above.

The present invention also features a newborn screening method for conducting a plurality of tests on blood from a newborn human to assay at least one analyte therefrom, the method comprising: (a) obtaining a test tray, the test tray comprising: (i) a plurality of cells; and (ii) at least two of the cells containing a dried internal standard used in each of the tests performed respectively on each test sample/standard in each cell after being provided with a solvent and blood sample; (b) placing a plurality of sample paper portions each bearing dried sample of blood from a newborn human into respective cells of the test tray; (c) placing aliquots of the blood into respective cells of the test tray so as to produce a respective plurality of test/standard samples; and (d) performing tandem mass spectrometry on each one of the respective plurality of test/standard samples.

The blood samples may be taken from blood spot sample paper that may be delivered to the laboratory from hospitals or clinics. Otherwise the blood sample may be provided in any other form appropriate to the desired test(s) and/or application, such as in the form of hemosylate, stored liquid blood or blood products or freeze dried samples, etc.

The tests performed on each of the respective plurality of test/standard samples might include the same or different tests or combination thereof as described herein. These may be tests for one or more of a wide variety of analytes (such as those measured against known or empirically developed thresholds or ranges) indicative of metabolic disorders, or otherwise indicating the need for further study of the tested individual.

The dried internal standard may be any appropriate standard for the desired test(s). The dried internal standards may be any standards known in the art, and may include those isotopically labeled either singly or in combination by H², C¹³ and N¹⁵, such those mentioned herein.

The method of the present invention also includes a method for conducting a plurality of tests on blood from a newborn human to assay at least one analyte therefrom, comprising: (a) obtaining a sample of blood from a newborn human; (b) placing aliquots of the blood in a plurality of cells of a test tray, the test tray comprising: (i) a plurality of cells; and (ii) at least two of the cells containing a dried internal standard used in each of the tests; so as to produce a respective plurality of test/standard samples; and (c) performing an assay test on each of the respective plurality of test/standard samples.

The blood spot extracts, containing the isotopically labeled standards may then be subject to chemical modification or analyzed directly. All conditions to which the sample is exposed also apply to the internal standard.

The tray may be made of any appropriate material, such as plastic or metal or combinations, and may contain cells of varying size and number. The cells may number preferably from 4 to 96. These may be arrayed in accordance with the number of tests to be conducted. The cells typically may be one-fourth inch to three-fourths inch in diameter.

The bodily fluid that may be tested is any bodily fluid upon which tests are performed and may include blood, semen, saliva, urine or spinal fluid.

The standards may be dried according to known methods including heat drying and freeze drying (lyophilization).

The number of tests that may be performed with each test tray may vary with the type of standard deposited in each cell. The tray may have all cells with a single standard or may contain one or more series adapted to perform one of a series of tests; for example, twenty cells with five series of four standards for four iterations of five different tests.

The preferred embodiment of the present invention utilizes dried isotopically labeled standards for newborn screening which are dissolved and used on a sample-by-sample basis. This avoids loss of solvent and consequent changes in internal standard concentration.

Typically, blood spots from newborns are taken from paper sample cards by punching portions of the blood spots to create samples. This is done using punching devices known in the art. The design of sampling cards varies, but typically the sampling cards contain from b 2 to 10 spots per card.

The spot punches are placed in the individual to cells in a multi-cell test tray. The blood samples are typically solvated, such as through the use of solvent such as methanol or ethanol.

At this point, the solvated samples are then transferred to a second multi-cell test tray. The sample that is typically derivatized to prepare the sample so that the molecules (i.e. typically amino acids and fatty acids) will be presented to the mass spectrometer in a protonated form. Typically, a derivatizing agent such as butanol-n-HCl is used for this purpose, or other appropriate derivatizing agent.

Transference of samples may be done in accordance with methods and through use of equipment known and used in the art, such as through use of multi-channel micropipettes and robotic dispensers.

The samples must then be dried again to remove excess derivatizing agent.

Finally, a protonation agent, such as a combination of acetonitrile and water, is added prior to the sample being analyzed by tandem mass spectroscopy. An internal standard, typically reconstituted from a dried the state into a liquid, is the added prior to the sample being analyzed.

In accordance with a preferred embodiment of the invention, the blood spot punches are placed in a multi-cell test tray, the test tray having cells already provided with a dried internal standard.

The blood samples and the dried internal standards in each cell of the test tray are solvated by addition of a protonation agent/solvent, such as a mixture of methanol and water.

In the preferred embodiment of the invention, the solvated test sample/standards are directly introduced into a tandem mass spectrometer that is adapted to process the test sample/standards using an electrospray. The tandem mass spectrometer may be any appropriate spectrometer such as, for instance, those commercially available from MDS SCIEX of Concord, Ontario Canada.

The preferred embodiment the invention thus eliminates the need to transfer, derivative and dry the test sample/standard mixtures from each cell. The preferred embodiment invention also eliminates the use of a separately prepared or stored standard solution, as the internal standard is reconstituted along with the spotted blood sample. This is also advantageous because stored internal standards are subject to contamination or changes in concentration owing to evaporation of the solvent (typically an alcohol). The preferred embodiment of the present invention overcomes the change in standard concentration by depositing solid samples of the standards in individual microtiter plate wells. These standards are then dissolved as the blood spot is extracted, and used in the same procedure. Any evaporation of the standard solvent and consequent uncertainty or error in the calculation of the amount of analyte present is avoided by treating the standard exactly the same as the analyte from the extraction step on through the procedure. Changes of concentration of the standard by evaporation are avoided by storing them dry, with no opportunity for the solvent to evaporate prior to use. Degradation of the acylcarnitine standards by hydrolysis is avoided by sealing the plate under dry air, followed by sealing the sealed plate in a desiccated package.

The methods for newborn screening may use testing protocols such as those described in Rashed et al., “Diagnosis of Inborn Errors of Metabolism from Blood Spots by Acylcarnitines and Amino Acids Profiling Using Automated Electrospray Tandem Mass Spectroscopy,” Pediatric Research, Vol. 38, no. 3, pp. 324-331 (1995); Chace et al., “Rapid Diagnosis of Homocystinuria and other Hypermethionimias from Newborns' Blood Spots by Tandem Mass Spectroscopy,” Clinical Chemistry, Vol. 42:3, pp. 349-355 (1996); Millington, et al., “Tandem Mass Spectroscopy: A New Method for Acylcarnitine Profiling with Potential for Neonatal Screening for Inborn Errors of Metabolism,” J. Inher. Metab. Dis. Vol. 13, pp. 321-324 (1990); Rashed et al., “Screening Blood Spots for Inborn Errors of Metabolism by Electrospray Tandem Mass Spectroscopy with a Microplate Bach Process and a Computer Algorithm for Automated Flagging,” Clinical Chemistry, Vol. 43:7, pp. 1129-1141 (1997); Magera et al., “Method for the Determination of Total Homocysteine in Plasma and Urine by Stable Isotope Dilution and Electrospray Tandem Mass Spectroscopy,” Clinical Chemistry, Vol. 45:9, pp. 1517-1522 (1999); Chace et al., “Use of Phenylalanine-to-Tyrosine Ratio Determined by Tandem Mass Spectrometry to Improve Newborn Screen for Phenylketonuria of Early Discharge Specimens Collected in the First 24 Hours,” Clinical Chemistry, Vol. 44:12, pp. 2405-2409 (1998); Chace et al., “Rapid Diagnosis of Phenylketonuria by Quantitative Analysis for Phenylalanine and Tyrosine in Neonatal Blood Spots by Tandem Mass Spectrometry,” Clinical Chemistry, Vol. 39:1, pp. 66-71 (1993); Chace et al., “Rapid Diagnosis of MCAD Deficiency: Quantitative Analysis of Octanoylcarnitine and Other Acylcarnitines in Newborn Blood Spots by Tandem Mass Spectrometry,” Clinical Chemistry, Vol. 43:11, pp. 2106-2113 (1997); Chace, et al., “Rapid Diagnosis of Phenylketonuria by Quantitative Analysis for Phenylalanine and Tyrosine in Neonatal Blood Spots by Tandem Mass Spectrometry,” Clinical Chem. vol. 38:66-71 (1993); Chace, et al., “Rapid Diagnosis of Maple Syrup Urine Disease in Blood Spots from Newborns by Tandem Mass Spectrometry,” Clinical Chem. vol. 41:62-8 (1995); Rashed, et al., “Electrospray Tandem Mass Spectrometry in the Diagnosis of Organic Acidemias'” Rapid Commun. Mass Spectrom. 8:129-33 (1994);

Rashed, et al., “Diagnosis of Inborn Errors of Metabolism from Blood Spots by Acylcarnitines and Amino Acid Profiling using Automated Electrospray Tandem Mass Spectrometry,” Pediatric Res. 38:324-331 (1995); Rinaldo, et al. “Medium Chain Acyl-CoA Dehydrogenase Deficiency. Diagnosis by Stable Isotope Dilution Measurement of Urinary N-Hexanoylglycine and 3-Phenylpropionylglycine,” New Eng. J. Med. Vol. 319:1308-1313 (1988); Magera, et al. “Method for the Determination of Total Homocysteine in Plasma and Urine by Stable Isotope Dilution and Electrospray Tandem Mass Spectrometry,” Clinical Chemistry, vol. 45:1517-22 (1999); Chace et al., “Rapid Diagnosis of Homocystinuria and Other Hypermethioninemias from Newborns' Blood Spots by Tandem Mass Spectrometry,” Clinical Chem. Vol. 42:349-355 (1996); Rashed, et al. “Screening Blood Spots for Inborn Errors of Metabolism by Electrospray Tandem Mass Spectrometry with a Microplate Batch Process and a Computer Algorithm for Automated Flagging of Abnormal Profiles. Clinical Chem., vol. 43:1129-42 (1997); Lowes et al., “Identification of Urinary Acy1carnitines using Gas Chromatography-Mass Spectrometry: Preliminary Clinical Applications,” J. Chromatogr. Vol. 577:205-14 (1992); Millington et al., “Tandem Mass Spectrometry: A New Method for Acylcarnitine Profiling for Neonatal Screening for Inborn Errors of Metabolism,” Journal of Inher. Metab. Dis. Vol. 13:321-324 (1990); Millington et al., “The Analysis of Diagnostic Markers of Genetic Disorders in Human Blood and Urine using Tandem Mass Spectrometry with Liquid Secondary Ion Mass Spectrometry. Int. J. Mass Spectrom. Ion Processes,” vol. 111: pp. 211-28 (1991); Millington et al., “New Developments in Fatty Acid Oxidation. In: Coates P M, Tanaka K eds. The Role of Tandem Mass Spectrometry in the Diagnosis of Fatty Acid Oxidation Disorders,” New York: Wiley-Liss, pp. 339-54 (1992); Chace, et al., “Rapid Diagnosis of MCAD Deficiency: Quantitative Analysis of Octanoylcarnitine and Other Acylcarnitines in Newborn Blood Spots by Tandem Mass Spectrometry,” Clinical Chemistry, vol. 43:11, pp. 2106-2113 (1997); Chace, et al., “Use of Phenylalanine-to-Tyrosine Ratio Determined by Tandem Mass Spectrometry to Improve Newborn Screening for Phenylketonuria of Early Discharge Specimens Collected in the First 24 Hours,” Clinical Chemistry, vol. 44:12, pp. 2405-2409 (1998); and Rashed, et al. “Diagnosis of Inborn Errors of Metabolism from Blood Spots by Acylcarnitines and Amino Acids Profiling Using Automated Electrospray Tandem Mass Spectrometry,” Clinical Chemistry, Vol. 38, No. 3 (1998).

All of the foregoing references are hereby incorporated herein by reference.

Also included in the present invention is a method of making a test tray comprising a plurality of test cells for conducting a plurality of tests on a biological fluid, the method comprising: (a) placing an aliquot of a liquid containing an internal standard is each of the test cells of the tray; and (b) drying the liquid containing an internal standard (as described herein), so as to form a layer of a pre-determined amount of dried internal standard upon the surface of each cell in the tray.

Drying may be carried out by any method appropriate to treatment of the internal standard, such as heat drying or lyophilization.

### BRIEF DESCRIPTION OF THE DRAWINGS

No drawings.

### DETAILED DESCRIPTION OF THE PREFERRED EMBODIMENT

As described above.

In light of the foregoing disclosure, it will be within the ability of one skilled in the newborn screening art to make modifications to the present invention, such as through the substitution of equivalent chemicals, compounds and their concentrations, or the application of equivalent process steps, without departing from the spirit of the invention reflected in the appended claims, which are hereby incorporated herein by reference.

What is claimed is: General Test Tray

1. A testing tray for conducting a plurality of tests on a biological fluid; said tray comprising:
(a) a test tray comprising a plurality of cells; and
(b) at least two of said cells containing a dried internal standard used in each respective said plurality of tests.

2. A testing tray according to claim 1 wherein said dried internal standard is an isotope labeled standard selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof.

3. A testing tray according to claim 1 additionally comprising a cover piece disposed over said cells.
General Assay Method Using Test Tray

4. A method of conducting a plurality of tests to assay analytes in a bodily fluid sample fluid, said method comprising:
(a) obtaining a sample of bodily fluid;
(b) placing aliquots of said bodily fluid sample in a plurality of cells of a test tray, said test tray comprising:
(i) a plurality of cells;
(ii) at least two of said cells containing a dried internal standard used in each of said tests; so as to produce a respective plurality of test/standard samples; and
(c) performing an assay test on each of said respective plurality of test/standard samples.

5. A method of conducting a plurality of tests according to claim 4 wherein said tests performed on each of said respective plurality of test/standard samples includes at least two tests adapted to assay different analytes from respective of said plurality of test/standard samples.

6. A method of conducting a plurality of tests according to claim 4 wherein said test includes at least two tests adapted to assay the same analyte from said respective plurality of test/standard samples.

7. A method of conducting a plurality of tests according to claim 4 wherein said test includes tandem mass spectrometry.
Kit Including Test Tray

8. A kit for conducting a plurality of tests to assay analytes in a bodily fluid, said kit comprising:
(a) a testing tray comprising a plurality of cells;
(b) at least two of said cells containing a dried internal standard, said dried internal standard is selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof; and
(c) a solvent for addition to said cells containing a dried internal standard.

9. A kit according to claim 8 additionally comprising a solvent dispenser micropipette.

10. A kit according to claim 9 wherein said solvent dispenser is a micropipette.
Newborn Blood Screening Test Tray

11. A testing tray for conducting a plurality of tests on blood from a newborn human, said tray comprising:
(a) a test tray comprising a plurality of cells; and
(b) at least two of said cells containing a dried internal standard used in each respective said plurality of tests, said dried internal standard selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof.
Newborn Screening Method Using Test Tray and Tandem Mass Spectrometry

12. A method of conducting a plurality of tests on blood from a newborn human to assay at least one analyte therefrom, said method comprising:
(a) obtaining a test tray, said test tray comprising:
(i) a plurality of cells; and
(ii) at least two of said cells containing a dried internal standard used in each of said tests;
(b) placing a plurality of sample paper portions each bearing dried sample of blood from a newborn human into respective cells of said test tray;
(c) placing aliquots of said blood into respective cells of said test tray so as to produce a respective plurality of test/standard samples; and
(d) performing tandem mass spectrometry on each of said respective plurality of test/standard samples.

13. A method of conducting a plurality of tests according to claim 12 wherein said tests performed on each of said respective plurality of test/standard samples includes at least two tests adapted to assay different analytes from respective of said plurality of test/standard samples.

14. A method of conducting a plurality of tests according to claim 12 wherein said test includes at least two tests adapted to assay the same analyte from said respective plurality of test/standard samples.

15. A method of conducting a plurality of tests according to claim 12 wherein said dried internal standard is an isotope labeled standard selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof.

16. A method of conducting a plurality of tests on blood from a newborn human to assay at least one analyte therefrom, said method comprising:
(a) obtaining a sample of blood from a newborn human;
(b) placing aliquots of said blood in a plurality of cells of a test tray, said test tray comprising:
(i) a plurality of cells; and
(ii) at least two of said cells containing a dried internal standard used in each of said tests; so as to produce a respective plurality of test/standard samples; and
(c) performing an assay test on each of said respective plurality of test/standard samples.
Method of Making a Test Tray

17. A method of making a testing tray comprising a plurality of test cells for conducting a plurality of tests on a biological fluid; said method comprising:
(a) placing an aliquot of a liquid containing an internal standard is each of said test cells of said tray; and
(b) drying said liquid containing an internal standard, so as to form a layer of dried internal standard upon the surface of each cell in said tray.

18. A method of making a testing tray according to claim 17 wherein said drying is done by lyophilization.

19. A method of making a testing tray according to claim 17 wherein said dried internal standard is an isotope labeled standard selected from the group consisting of carnitine, acetyl carnitine, propionyl carnitine, butryl carnitine, isovaleryl carnitine, octanoyl carnitine, myristoyl carnitine, palmitoyl carnitine, glycine, alanine, valine, leucine, methionine, phenylalanine, tyrosine, aspartate, glutamate, ornithine, citrulline, arginine, polysaccharides, polysaccharides bound to protein or protein fragments, and mixtures thereof.
